(19) United States
(12) Patent Application Publication
(10) Pub. No.: US 2025/0242575 A1
(43) Pub. Date: Jul. 31, 2025

(54) HARDCOAT-LESS FILM, LAMINATE, MULTILAYER LAMINATE, AND DISPLAY DEVICE

(71) Applicant: DAICEL CORPORATION, Osaka (JP)

(72) Inventors: Yusaku SAINOHIRA, Tokyo (JP); Akihiro SHIBAMOTO, Tokyo (JP)

(73) Assignee: DAICEL CORPORATION, Osaka (JP)

(21) Appl. No.: 19/034,374

(22) Filed: Jan. 22, 2025

(30) Foreign Application Priority Data
Jan. 26, 2024 (JP) 2024-010562

(51) Int. Cl. B32B 27/28; B32B 27/08; C08G 77/00; C08G 77/46; C08J 5/18

(52) U.S. Cl. CPC B32B 27/283; B32B 27/08; B32B 27/28; C08G 77/46; C08J 5/18; B32B 2250/24; B32B 2307/30; B32B 2307/536; B32B 2307/54; B32B 2307/7376; B32B 2457/20; C08G 77/80; C08J 2383/12

(57) ABSTRACT

[Problem]

Provided is a hardcoat-less film that is relatively lightweight, has excellent mechanical strength, and has excellent heat resistance even without regulated PFAS substance.

[Solution]

A hardcoat-less film that fulfills a condition that an elastic-to-plastic ratio is 70% or more in an indentation test and a glass transition temperature and a melting point each are neither lower than nor equal to 200° C., and fulfills at least one of a condition that a Young's modulus is 1000 MPa or more in an indentation test or a condition that a Young's modulus is from 1000 to 5000 MPa in a tensile test.

[Selected Drawing] None

### TECHNICAL FIELD

The present disclosure relates to a hardcoat-less film, a laminate, a multilayer laminate, and a display device. Specifically, the present disclosure relates to a hardcoat-less film; and a laminate, a multilayer laminate, and a display device, each of which includes the hardcoat-less film.

### BACKGROUND ART

Monitors such as a liquid crystal display, an organic EL display, or a plasma display have a protective film attached thereon or a hardcoat layer formed thereon, and this is effective at preventing a screen from being scratched, making the screen unsusceptible to fingerprints, and making it easy to wipe off dirt adhered on the screen.

With the development of mobile devices such as smartphones and tablet PCs, in recent years, optical base materials such as base materials for displays are required to be thinned or slimmed down. For this reason, base materials for coating the hardcoat layer have also become thinner and more slimmed down.

As the base material, glass, polyimide, and polyethylene terephthalate (PET) are commonly used. However, glass is heavy in weight per se, which results in an increased weight of a mobile device, and also has a problem of easy breakage upon impact. Moreover, polyimide often contains a fluorinated alkyl in its structure, which is subject to the organic fluorine compound (PFAS) regulations in recent years, and such polyimide may be restricted in use in some regions. Furthermore, PET has a problem of low heat resistance.

In addition, from a point of view of thinning, there has been proposed a single-layer film excellent in abrasion resistance of the surface, which does not require a hardcoat layer or a supporting base material. For example, Patent Document 1 discloses a hard coating film containing a crosslinked polymer of a urethane acrylate oligomer, and Patent Document 2 discloses a base material-less type cover window for a flexible display device, which contains an elastomer and a polysiloxane that contains an epoxy group-containing functional group.

### CITATION LIST

### Patent Document

Patent Document 1: JP 2017-214553 A

Patent Document 2: KR 10-2023-0050843 A

### SUMMARY OF INVENTION

### Technical Problem

However, the film of Patent Document 1 had a crosslinking density of about 60% and is insufficient in mechanical strength. In addition, the cover window of Patent Document 2 also is insufficient in mechanical strength as it contains an elastomer. Moreover, heat resistance is required in some cases even when a single-layer film is used.

Therefore, an object of the present disclosure is to provide a hardcoat-less film that is relatively lightweight, has excellent mechanical strength, and has excellent heat resistance even without regulated PFAS substance. In addition, an object of the present disclosure is to provide a laminate, a multilayer laminate, and a display device, each of which includes the hardcoat-less film.

### Solution to Problem

As a result of intensive studies to solve the above-mentioned problems, the inventors of the present disclosure have found that a hardcoat-less film having specific physical properties is relatively lightweight and excellent in mechanical strength even without any regulated PFAS substance. The present invention has been completed based on these findings.

That is, the present disclosure provides a hardcoat-less film that fulfills a condition that an elastic-to-plastic ratio is 70% or more in an indentation test and a glass transition temperature and a melting point each are neither lower than nor equal to 200° C.; and fulfills at least one of a condition that a Young's modulus is 1000 MPa or more in an indentation test or a condition that a Young's modulus is from 1000 to 5000 MPa in a tensile test.

The hardcoat-less film has a thickness of from 1 to 1000 μm and an indentation hardness of 100 MPa or more in an indentation test.

The hardcoat-less film is preferably formed of a cured product of a curable composition, and the cured product preferably has a glass transition temperature of 300°° C. or higher.

The hardcoat-less film is preferably formed of a cured product of a curable composition, and the cured product preferably has a pencil hardness of 2H or more. The curable composition preferably contains a radical-curable polyorganosiloxane.

The curable composition preferably contains cationically polymerizable silsesquioxane.

The curable composition preferably further contains a curable compound having an active energy ray polymerizable functional group.

In addition, the present disclosure provides a laminate including the hardcoat-less film and a functional layer that is layered on the hardcoat-less film. The present disclosure also provides a multilayer laminate in which a plurality of the laminates is layered.

Furthermore, the present disclosure provides a display device including the multilayer laminate.

### ADVANTAGEOUS EFFECTS OF INVENTION

According to the present disclosure, it is possible to provide a hardcoat-less film that is relatively lightweight, is excellent in mechanical strength, and is excellent in heat resistance even without regulated PFAS substance; and a laminate, a multilayer laminate, and a display device, each of which includes the hardcoat-less film.

### DESCRIPTION OF EMBODIMENTS

### Hardcoat-Less Film

The hardcoat-less film of the present disclosure fulfills a condition that an elastic-to-plastic ratio is 70% or more in an indentation test and a glass transition temperature and a melting point each are neither lower than nor equal to 200° C.; and fulfills at least one of a condition that a Young's modulus is 1000 MPa or more in an indentation test or a condition that a Young's modulus is from 1000 to 5000 MPa in a tensile test. In particular, the hardcoat-less film preferably fulfills both conditions of a Young's modulus of 1000 MPa or more in an indentation test and a Young's modulus of from 1000 to 5000 MPa in a tensile test.

In the present specification, the “hardcoat-less film” refers to a film (sheet) on both sides of which no hardcoat layer is formed and which has a hardcoat property as a single film layer. The hardcoat-less film is not required to be additionally provided with a hardcoat layer, and can be relatively lightweight.

The hardcoat-less film has an elastic-to-plastic ratio in an indentation test of 70% or more, preferably of 75% or more, and more preferably of 80% or more. When the elastic-to-plastic ratio is 70% or more, scratches are less likely to occur when stress is applied, and the film is excellent in mechanical strength. The elastic-to-plastic ratio is preferably 95% or less, more preferably 95% or less, and still more preferably 90% or less. When the elastic-to-plastic ratio is 95% or less, the hardcoat-less film is excellent in flexibleness and excellent in flex resistance.

The hardcoat-less film preferably has a Young's modulus of 1000 MPa or more, more preferably 2000 MPa or more, and still more preferably 3000 MPa or more in an indentation test. When the Young's modulus in an indentation test is 1000 MPa or more, the hardness is enough to prevent scratches, and the film is excellent in mechanical strength. The Young's modulus in an indentation test is preferably 10000 MPa or less, more preferably 9000 MPa or less, and still more preferably 8000 MPa or less. When the Young's modulus in an indentation test is 10000 MPa or less, the film is excellent in flexibleness and excellent in flex resistance.

The hardcoat-less film preferably has an indentation hardness of 100 MPa or more, more preferably 300 MPa or more, and still more preferably 700 MPa or more in an indentation test. When the indentation hardness is 100 MPa or more, the surface hardness is enhanced and dents and scratches are less likely to occur, and the film is excellent in mechanical strength. Moreover, the indentation hardness is preferably 1000 MPa or less, more preferably 900 MPa or less, and still more preferably 800 MPa or less. When the indentation hardness is 1000 MPa or less, the film is excellent in flexibleness and excellent in flex resistance.

In the indentation hardness can be measured by, for example, a nanoindentation technique. As an indenter, a Berkovich tip can be used.

The hardcoat-less film preferably has a Young's modulus of from 1000 to 5000 MPa, more preferably from 1200 to 4000 MPa, and still more preferably from 1500 to 3000 MPa in a tensile test. When the Young's modulus is 1000 MPa or more in a tensile test, stiffness required for forming the film is maintained, and the film is excellent in mechanical strength. When the Young's modulus is 5000 MPa or less in a tensile test, both elongation and flex resistance can be achieved while maintaining stiffness, and the film is excellent in mechanical strength.

The tensile test can be performed by using a known or commonly used tensile tester. The Young's modulus is a value measured using a sheet of hardcoat-less film having No. 7 dumbbell-shape as a test piece under conditions of an initial chuck distance of 20 mm, a gauge length of 12 mm, and a tensile test speed of 2 mm/min in an ambient temperature environment. In addition, the Young's modulus in the tensile test can be determined by calculating an average value from the measured values of five or more test pieces (n=5 or more) after removing the maximum and minimum values thereof.

The hardcoat-less film preferably has a glass transition temperature (Tg) and a melting point (Tm) of neither lower than nor equal to 200° C., and more preferably has a glass transition temperature (Tg) and a melting point (Tm) of neither lower than nor equal to 300° C. When the glass transition temperature and the melting point each are neither lower than nor equal to 200° C., the hardcoat-less film is excellent in heat resistance. The glass transition temperature and the melting point are values measured by DSC (differential scanning calorimetry).

The thickness of the hardcoat-less film is preferably from 1 to 1000 μm, more preferably from 10 to 600 μm, and still more preferably from 30 to 400 μm. When the thickness is 1 μm or more, the film is more excellent in mechanical strength and abrasion resistance. When the thickness is 1000 μm or less, the film has a further reduced weight and is excellent in flex resistance.

### Curable Composition

The hardcoat-less film is preferably formed of a cured product of a curable composition. That is, the curable composition preferably contains a curable compound. A single type of the curable compound may be used alone, or two or more types thereof may be used.

The curable compound is preferably a cationically polymerizable silsesquioxane. When the curable composition contains the cationically polymerizable silsesquioxane, the curable composition is less likely to shrink during curing, and a relatively thick hardcoat-less film can be easily produced, whereby a hardcoat-less film having more excellent abrasion resistance can be produced. The cationically polymerizable silsesquioxane is preferably a photocationically polymerizable silsesquioxane.

The cationically polymerizable silsesquioxane has a cationically polymerizable functional group in the molecule. Examples of the cationically polymerizable functional group include a hydroxy group, an epoxy group, an oxetane group, a vinyl ether group, and a vinyl phenyl group. Among them, an epoxy group is preferable from a point of view of further increasing the surface hardness of the hardcoat-less film.

Examples of a group containing the epoxy group include known or commonly used groups having an oxirane ring, and are not particularly limited, but from a point of view of the curability of the curable composition and the heat resistance of the hardcoat-less film, a group represented by Formula (la) below, a group represented by Formula (1b) below, a group represented by Formula (1c) below, and a group represented by Formula (1d) below are preferable, a group represented by Formula (1a) below and a group represented by Formula (1c) below are more preferable, and a group represented by Formula (1a) below is still more preferable.

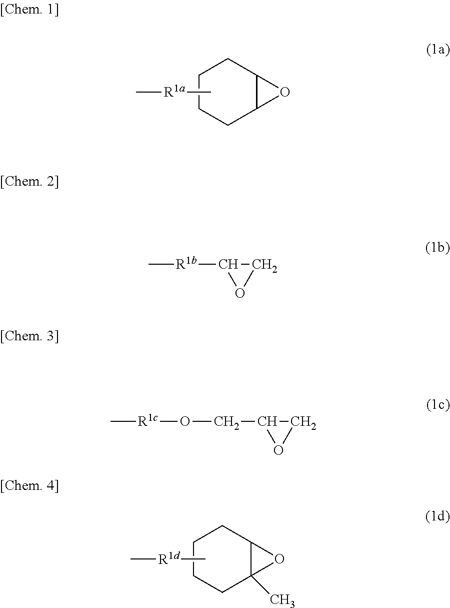

In Formula (1a) above, R^{1a}represents a linear or branched alkylene group. Examples of the linear or branched alkylene group include linear or branched alkylene groups having from 1 to 10 carbons, such as a methylene group, a methylmethylene group, a dimethylmethylene group, an ethylene group, a propylene group, a trimethylene group, a tetramethylene group, a pentamethylene group, a hexamethylene group, and a decamethylene group. Among them, from a point of view of curability of the curable composition, R^{1a} is preferably a linear alkylene group having from 1 to 4 carbons or a branched alkylene group having from 3 or 4 carbons, more preferably an ethylene group, a trimethylene group, or a propylene group, and still more preferably an ethylene group or a trimethylene group.

In Formula (1b) above, R^{1b} represents a linear or branched alkylene group, and examples thereof include groups similar to those exemplified as R^{1a}. Among them, from a point of view of curability of the curable composition, R^{1b} is preferably a linear alkylene group having from 1 to 4 carbons or a branched alkylene group having from 3 or 4 carbons, more preferably an ethylene group, a trimethylene group, or a propylene group, and still more preferably an ethylene group or a trimethylene group.

In Formula (1c) above, R^{1c} represents a linear or branched alkylene group, and examples thereof include groups similar to those exemplified as R^{1a}. Among them, from a point of view of curability of the curable composition, R^{1e} is preferably a linear alkylene group having from 1 to 4 carbons or a branched alkylene group having from 3 or 4 carbons, more preferably an ethylene group, a trimethylene group, or a propylene group, and still more preferably an ethylene group or a trimethylene group.

In Formula (1d) above, R^{1d} represents a linear or branched alkylene group, and examples thereof include groups similar to those exemplified as R^{1a}. Among them, from a point of view of curability of the curable composition, R^{1d} is preferably a linear alkylene group having from 1 to 4 carbons or a branched alkylene group having from 3 or 4 carbons, more preferably an ethylene group, a trimethylene group, or a propylene group, and still more preferably an ethylene group or a trimethylene group.

R¹ in Formula (1) is preferably a group represented by Formula (1) above in particular, in which R^{1a}is an ethylene group [especially, 2-(3,4-epoxycyclohexyl)ethyl group].

Examples of the cationically polymerizable silsesquioxane include a compound having a constituent unit represented by Formula (1) below.

[R¹SiO_{3/2}] (1)

The constituent unit represented by Formula (1) above is a silsesquioxane constituent unit (so-called T unit) typically represented by [RSiO_{3/2}]. Note that, R in the Formula above represents a hydrogen atom or a monovalent organic group, and the same applies to the following. The constituent unit represented by Formula (1) above is formed by hydrolysis and condensation reaction of a corresponding hydrolyzable trifunctional silane compound. Note that, in the present specification, the compound having the constituent unit represented by Formula (1) above may be referred to as “silsesquioxane (X)”. R¹ in Formula (1) represents a group (monovalent group) containing the cationically polymerizable functional group.

The silsesquioxane (X) may include only one type of the constituent unit represented by Formula (1) above, or may include two or more types of the constituent units represented by Formula (1) above.

The silsesquioxane (X) may include a constituent unit represented by Formula (2) below as the silsesquioxane constituent unit [RSiO_{3/2}], besides the constituent unit represented by Formula (1) above.

[R²SiO_{3/2}] (2)

The constituent unit represented by Formula (2) above is a silsesquioxane constituent unit (T unit) typically represented by [RSiO_{3/2}]. That is, the constituent unit represented by Formula (2) above is formed by hydrolysis and condensation reaction of the corresponding hydrolyzable trifunctional silane compound.

R² in Formula (2) above represents a substituted or unsubstituted aryl group, a substituted or unsubstituted aralkyl group, a substituted or unsubstituted cycloalkyl group, or a substituted or unsubstituted alkyl group. Examples of the aryl group include a phenyl group, a tolyl group, and a naphthyl group. Examples of the aralkyl group include a benzyl group and a phenethyl group. Examples of the cycloalkyl group include a cyclobutyl group, a cyclopentyl group, and a cyclohexyl group. Examples of the alkyl group include linear or branched alkyl groups, such as a methyl group, an ethyl group, a propyl group, a n-butyl group, an isopropyl group, an isobutyl group, a s-butyl group, a t-butyl group, and an isopentyl group.

Examples of the substituted aryl group, substituted aralkyl group, substituted cycloalkyl group, and substituted alkyl group set forth above include a group in which some or all of hydrogen atoms or a part or whole of a main chain skeleton in the respective aryl group, aralkyl group, cycloalkyl group, and alkyl group set forth above is substituted with at least one selected from the group consisting of an alkyl group (especially, a linear or branched alkyl group having from 1 to 10 carbons), an ether group, an ester group, a carbonyl group, a siloxane group, a halogen atom (such as fluorine atom), a mercapto group, an amino group, and a hydroxy group (hydroxyl group).

Among them, R² is preferably a substituted or unsubstituted aryl group or a substituted or unsubstituted alkyl group, more preferably a substituted or unsubstituted aryl group, and still more preferably a phenyl group.

The proportion of each of the silsesquioxane constituent units (constituent unit represented by Formula (1) and constituent unit represented by Formula (2)) in the silsesquioxane (X) can be appropriately adjusted by the composition of the raw material (hydrolyzable trifunctional silane) for forming these constituent units.

Among them, the silsesquioxane (X) preferably contains at least a constituent unit represented by Formula (1) above in which R¹ is a group containing an alicyclic epoxy group or a constituent unit represented by Formula (2) above in which R² is an aryl group optionally having a substituent. In this case, the hardcoat-less film tends to be more excellent in surface hardness, flexibility, processability, and flame retardancy.

The silsesquioxane (X) may further include at least one type of siloxane constituent unit selected from the group consisting of a constituent unit represented by [R³SiO_{1/2}](so-called M unit), a constituent unit represented by [R²SiO_{2/2}](so-called D unit), and a constituent unit represented by [SiO_{4/2}](so-called Q unit), besides the constituent unit represented by Formula (1) above and the constituent unit represented by Formula (2) above which are T units. Note that, examples of R in the M unit and in the D unit include groups similar to those exemplified as R¹ in the constituent unit represented by Formula (1) above and groups similar to those exemplified as the constituent unit R² represented by Formula (2) above. Examples of the silsesquioxane constituent unit other than the constituent unit represented by Formula (1) above and the constituent unit represented by Formula (2) above include a constituent unit represented by Formula (3) below.

[HSiO_{3/2}] (3)

The silsesquioxane (X) contains a constituent unit (T3 form) represented by Formula (I) below. Furthermore, the silsesquioxane (X) may contain a constituent unit (T2 form) represented by Formula (II) below.

[R^{a}SiO_{3/2}] (I)

[R^{b}SiO_{2/2}(OR^{c})] (II)

The constituent unit represented by Formula (I) above is represented by Formula (I′) below in more detail. Furthermore, the constituent unit represented by Formula (II) above is represented by Formula (II') below in more detail. Three oxygen atoms bonded to the silicon atom illustrated in the structure represented by formula (I′) below are each bonded to another silicon atom (a silicon atom not illustrated in formula (I′)). On the other hand, two oxygen atoms located above and below the silicon atom illustrated in the structure represented by Formula (II′) below are each bonded to another silicon atom (a silicon atom not illustrated in Formula (II')). That is, the T3 form and the T2 form each are a constituent unit (T unit) formed by hydrolysis and condensation reaction of the corresponding hydrolyzable trifunctional silane compound.

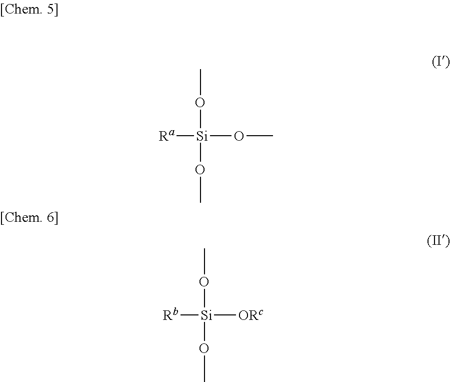

R^{a} in Formula (I) above (and also R^{a} in Formula (I′)) and R^{b} in Formula (II) (and also R^{b} in Formula (II')) each represent a group that contains a cationically polymerizable functional group, a substituted or unsubstituted aryl group, a substituted or unsubstituted aralkyl group, a substituted or unsubstituted cycloalkyl group, a substituted or unsubstituted alkyl group, or a hydrogen atom. Specific examples of R^{a} and R^{b} include those similar to those exemplified as R¹ in Formula (1) above and R² in Formula (2) above. Note that, R^{a} in Formula (I) and R^{b} in Formula (II) each are a group derived from a group (a group other than an alkoxy group and a halogen atom) bonded to a silicon atom in the hydrolyzable trifunctional silane compound used as a raw material for the silsesquioxane (X), or a group produced from epoxidation of a group (a group other than an alkoxy group and a halogen atom) bonded to a silicon atom in the hydrolyzable trifunctional silane compound used as a raw material for the silsesquioxane (X) when the cationically polymerizable functional group is an epoxy group, for example.

R^{c} in Formula (II) above (and also Re in Formula (II')) represents a hydrogen atom or an alkyl group having from 1 to 4 carbons. Examples of the alkyl group having from 1 to 4 carbons include linear or branched alkyl groups having from 1 to 4 carbons, such as a methyl group, an ethyl group, a propyl group, an isopropyl group, a butyl group, and an isobutyl group. Among them, a methyl group and an ethyl group are preferable, and a methyl group is more preferable. The alkyl group in R^{c} in Formula (II) is typically derived from an alkyl group forming an alkoxy group in the hydrolyzable silane compound used as a raw material for the silsesquioxane (X).

The mole ratio of the constituent unit (T3 form) represented by Formula (I) above to the constituent unit (T2 form) represented by Formula (II) above in the silsesquioxane (X) [the constituent unit represented by Formula (I)/the constituent unit represented by Formula (II)] (described as “T3 form/T2 form” in some cases) is not particularly limited, but is preferably 5 or more, more preferably from 5 to 20, still more preferably from 5 to 18, still more preferably from 6 to 16, still more preferably from 7 to 15, and particularly preferably from 8 to 14. When the mole ratio [T3 form/T2 form] is 5 or more, the surface hardness of the hardcoat-less film tends to be further enhanced.

The mole ratio [T3 form/T2 form] in the silsesquioxane (X) can be determined by, for example, 29Si-NMR spectroscopy. In ²⁹Si-NMR spectrum, the silicon atom in the constituent unit (T3 form) represented by Formula (I) above and the silicon atom in the constituent unit (T2 form) represented by Formula (II) exhibit signals (peaks) at different positions (chemical shifts), and thus the mole ratio [T3 form/T2 form] can be determined by calculating the ratio of the integrated intensities of these peaks. Specifically, for example, when the silsesquioxane (X) includes a constituent unit represented by Formula (1) above in which R1 is a 2-(3,4-epoxycyclohexyl)ethyl group, a signal of a silicon atom in the structure (T3 form) represented by Formula (I) above appears from-64 to-70 ppm, and a signal of a silicon atom in the structure (T2 form) represented by Formula (II) above appears from −54 to −60 ppm. Therefore, in this case, the mole ratio [T3 form/T2 form] can be determined by calculating the ratio of the integrated intensity of the signal (T3 form) from −64 to −70 ppm to the integrated intensity of the signal (T2 form) from −54 to −60 ppm.

The ²⁹Si-NMR spectrum of the silsesquioxane (X) can be measured by, for example, the following instrument and conditions.
Measurement instrument: Product name “JNM-ECA500NMR” (available from JEOL Ltd.)
Solvent: deuterated chloroform
Cumulative number of scans: 1800
Measurement temperature: 25° C.

The mole ratio [T3 form/T2 form] of 5 or more in the silsesquioxane (X) means that a certain amount or more of T2 forms are present relative to T3 forms in the silsesquioxane (X). Examples of such a T2 form include a constituent unit represented by Formula (4) below, a constituent unit represented by Formula (5) below, and a constituent unit represented by Formula (6) below. R¹ in Formula (4) below and R² in Formula (5) below are the same as R¹ in Formula (1) above and R² in Formula (2) above, respectively. R^{c} in Formulae (4) to (6) below represents a hydrogen atom or an alkyl group having from 1 to 4 carbons, as with R^{c} in Formula (II).

[R¹SiO_{2/2}(OR^{c})] (4)

[R²SiO_{2/2}(OR^{c})] (5)

[HSiO_{2/2}(OR^{c})] (6)

The cationically polymerizable silsesquioxane (especially, silsesquioxane (X)) may be a silsesquioxane having a cage shape (cage-type silsesquioxane). Examples of the cage-type silsesquioxane include a complete cage-type silsesquioxane and an incomplete cage-type silsesquioxane, and among them, an incomplete cage-type silsesquioxane is preferable.

Typically, a complete cage-type silsesquioxane is a polyorganosilsesquioxane constituted of a T3 form only, and no T2 form is present in the molecule. That is, if a silsesquioxane has the mole ratio [T3 form/T2 form] of 5 or more and further has a single intrinsic absorption peak at around 1100 cm⁻¹ in the FT-IR spectrum as described later, this suggests that the silsesquioxane has an incomplete cage-type silsesquioxane structure.

Whether the silsesquioxane (X) has a cage-type (incomplete cage-type) silsesquioxane structure can be confirmed by FT-IR spectrum [refer to R. H. Raney, M. Itoh, A. Sakakibara and T. Suzuki, Chem. Rev. 95, 1409 (1995)]. Specifically, if the silsesquioxane (X) has no intrinsic absorption peaks each at around 1050 cm⁻¹ and at around 1150 cm⁻¹ and has a single intrinsic absorption peak at around 1100 cm⁻¹ in FT-IR spectrum, the silsesquioxane (X) can be identified as having a cage-type (incomplete cage-type) silsesquioxane structure. In contrast, typically, if the silsesquioxane has intrinsic absorption peaks each at around 1050 cm⁻¹ and at around 1150 cm⁻¹ in FT-IR spectrum, the silsesquioxane (X) can be identified as having a ladder type silsesquioxane structure. Note that the FT-IR spectrum of the silsesquioxane (X) can be measured by, for example, the following instrument and conditions.
Measurement instrument: Product name “FT-720” (available from HORIBA, Ltd.)
Measurement method: Transmission method
Resolution: 4 cm⁻¹
Measurement wavenumber range: from 400 to 4000 cm⁻¹
Cumulative number of scans: 16

The proportion (total amount) of the constituent unit having a cationically polymerizable functional group (e.g., the constituent unit represented by Formula (1) above, the constituent unit represented by Formula (4) above etc.) to the total amount of siloxane constituent units [total siloxane constituent units; total amount of M, D, T, and Q units] (100 mol %) in the cationically polymerizable silsesquioxane is not particularly limited, but is preferably 50 mol % or more (e.g., from 50 to 100 mol %), more preferably from 55 to 100 mol %, more preferably from 65 to 99.9 mol %, still more preferably from 80 to 99 mol %, and particularly preferably from 90 to 98 mol %. When the proportion is 50 mol % or more, the curability of the curable composition is enhanced, and the surface hardness of the hardcoat-less film is significantly increased. Note that the proportion of each of the siloxane constituent units in the cationically polymerizable silsesquioxane can be calculated, for example, by the composition of the raw material, NMR spectroscopy, etc.

The proportion of the constituent unit (T3 form) represented by Formula (I) above to the total amount of siloxane constituent units [total siloxane constituent units; total amount of M, D, T, and Q units] (100 mol %) in the silsesquioxane (X) is not particularly limited, but is preferably 50 mol % or more, more preferably from 60 to 99 mol %, still more preferably from 70 to 98 mol %, still more preferably from 80 to 95 mol %, and particularly preferably from 85 to 92 mol %. When the proportion of the constituent unit of the T3 form is 50 mol % or more, the surface hardness of the hardcoat-less film tends to be further improved, this is presumably because an incomplete cage shape having an appropriate molecular weight is easily formed.

The proportion (total amount) of the constituent unit represented by Formula (2) above and the constituent unit represented by Formula (5) above to the total amount of siloxane constituent units [total siloxane constituent units; total amount of M, D, T, and Q units] (100 mol %) in the silsesquioxane (X) is not particularly limited, but is preferably from 0 to 50 mol %, more preferably from 0 to 40 mol %, still more preferably from 0 to 30 mol %, and particularly preferably from 1 to 15 mol %. When the proportion is 50 mol % or less, the curability of the curable composition tends to be improved and the surface hardness of the hardcoat-less film tends to be enhanced, this is because the proportion of the constituent unit having a cationically polymerizable functional group can be relatively increased.

The proportion (total amount) of the constituent unit represented by Formula (I) above and the constituent unit represented by Formula (II) above (especially, the proportion of the sum of the T3 form and the T2 form) to the total amount of siloxane constituent units [total siloxane constituent units; total amount of M, D, T, and Q units] (100 mol %) in the silsesquioxane (X) is not particularly limited, but is preferably 60 mol % or more (e.g., from 60 to 100 mol %), more preferably 70 mol % or more, still more preferably 80 mol % or more, and particularly preferably 90 mol % or more. When the proportion is 60 mol % or more, the surface hardness of the hardcoat-less film tends to be further enhanced, this is presumably because an incomplete cage shape having an appropriate molecular weight is easily formed. In particular, the proportion (total amount) of the constituent unit represented by Formula (1) above, the constituent unit represented by Formula (2) above, the constituent unit represented by Formula (4) above, and the constituent unit represented by Formula (5) above is preferably within the range set forth above.

The number average molecular weight (Mn) of the silsesquioxane (X) calibrated with standard polystyrene measured by gel permeation chromatography is not particularly limited, but is preferably from 1000 to 3000, more preferably from 1000 to 2800, still more preferably from 1100 to 2600, and particularly preferably from 1500 to 2500. When the number average molecular weight is 1000 or more, the surface hardness of the hardcoat-less film tends to be further enhanced. In addition, the heat resistance and abrasion resistance of the hardcoat-less film tend to be improved. On the other hand, when the number average molecular weight is 3000 or less, miscibility with other components in the curable composition is improved, and the heat resistance of the hardcoat-less film tends to be improved.

The molecular weight dispersity (Mw/Mn) of the silsesquioxane (X) calibrated with standard polystyrene measured by gel permeation chromatography is not particularly limited, but is preferably from 1.0 to 3.0, more preferably from 1.1 to 2.0, still more preferably from 1.2 to 1.9, still more preferably from 1.3 to 1.8, and particularly preferably from 1.45 to 1.80. When the molecular weight dispersity is 3.0 or less, the surface hardness of the hardcoat-less film tends to be enhanced. On the other hand, when the molecular weight dispersity is 1.0 or more (especially, 1.1 or more), the silsesquioxane (X) tends to become liquid, and ease of handling tends to be improved.

Note that the number average molecular weight and molecular weight dispersity of the silsesquioxane (X) can be measured by the following instrument and conditions.
Measurement instrument: Product name “LC-20AD” (available from Shimadzu Corporation)
Columns: Shodex KF-801×2, KF-802, and KF-803 (available from Showa Denko K.K.)
Measurement temperature: 40° C.
Eluent: THF, sample concentration of from 0.1 to 0.2 wt. %
Flow rate: 1 mL/min
Detector: UV-VIS detector (Product name: “SPD-20A”, available from Shimadzu Corporation)
Molecular weight: calibrated with standard polystyrene

The cationically polymerizable silsesquioxane can be produced by a known or commonly used method for producing a silsesquioxane, and the method is not particularly limited, however, the cationically polymerizable silsesquioxane can be produced by, for example, a method in which one or two or more types of hydrolyzable silane compounds are hydrolyzed and condensed.

The content proportion of the cationically polymerizable silsesquioxane in the curable composition is not particularly limited, but is preferably more than 50 mass % (e.g., more than 50 mass % and 98 mass % or less), more preferably from 60 to 95 mass %, still more preferably from 70 to 93 mass %, and particularly preferably from 80 to 90 mass % per the total amount (100 mass %) of the curable compound. When the content proportion is more than 50 mass %, the surface hardness of the hardcoat-less film tends to be further improved. When the content proportion is 98 mass % or less, other components can be blended, and the effect provided from the blending of these components tends to be further enhanced. In addition, a curing catalyst can be blended, and in such a case, the curing of the curable composition tends to proceed more efficiently.

The curable compound preferably contains a curable compound having an active energy ray polymerizable functional group (referred to as an “active energy ray-curable compound” in some cases). In this case, the dispersibility of the radical-curable polyorganosiloxane described below in the curable composition and in the hardcoat-less film can be enhanced. Note that the active energy ray-curable compound is a compound that does not correspond to the cationically polymerizable silsesquioxane.

Examples of the active energy ray polymerizable functional group include a vinyl group, a propenyl group, an isopropenyl group, and a (meth)acryloyl group (an acryloyl group, a methacryloyl group). Among them, a (meth)acryloyl group is preferable.

The number of the unsaturated bonds included in the active energy ray-curable compound is 1 or more, preferably from 1 to 6, more preferably from 1 to 3, still more preferably from 1 to 2, and particularly preferably 1.

The active energy ray-curable compound may include a cationically polymerizable functional group in the molecule. In this case, the active energy ray-curable compound has reactivity with the cationically polymerizable silsesquioxane, and a hardcoat-less film having higher mechanical strength and enhanced surface hardness can be produced. Examples of the cationically polymerizable functional group that can be included in the active energy ray-curable compound include those exemplified and described as the cationically polymerizable functional group included in the cationically polymerizable silsesquioxane, and among them, an epoxy group is preferable.

The number of the cationically polymerizable functional groups included in the active energy ray-curable compound is 1 or more, preferably from 1 to 5, more preferably from 1 to 3, and particularly preferably from 1 or 2.

The functional group equivalent of the active energy ray polymerizable functional group in the active energy ray-curable compound is not particularly limited, but is preferably from 50 to 500, more preferably from 80 to 480, and still more preferably from 120 to 450. When the functional group equivalent is 50 or more, the hardcoat-less film is more excellent in flex resistance. When the functional group equivalent is 500 or less, the surface hardness of the hardcoat-less film is further enhanced. Note that the functional group equivalent can be calculated by the following equation.

[Functional group equivalent of active energy ray polymerizable functional group]=[Molecular weight of the active energy ray-curable compound]/[Number of active energy ray polymerizable functional groups included in the active energy ray-curable compound]

The functional group equivalent of the cationically polymerizable functional group in the active energy ray-curable compound is not particularly limited, but is preferably from 50 to 500, more preferably from 80 to 480, and still more preferably from 120 to 450. When the functional group equivalent is 50 or more, the hardcoat-less film is more excellent in flex resistance. When the functional group equivalent is 500 or less, the surface hardness of the hardcoat-less film is further enhanced. Note that the functional group equivalent can be calculated by the following equation.

[Functional group equivalent of cationically polymerizable functional group]=[Molecular weight of the active energy ray-curable compound]/[Number of cationically polymerizable functional groups included in the active energy ray-curable compound]

The active energy ray-curable compound preferably has a polyether skeleton such as a polyethylene glycol skeleton, a polypropylene glycol skeleton, or a polyglycerin skeleton.

Specific examples of the active energy ray-curable compound include: compounds having a (meth)acryloyl group and an epoxy group and/or a hydroxyl group in one molecule, such as 3,4-epoxycyclohexylmethyl (meth)acrylate, glycidyl (meth)acrylate, tripropylene glycol diglycidyl ether di(meth) acrylate (a compound produced by reacting (meth)acrylic acid with both epoxy groups of tripropylene glycol diglycidyl ether), tripropylene glycol diglycidyl ether half (meth)acrylate (a compound produced by reacting (meth)acrylic acid with one epoxy group of tripropylene glycol diglycidyl ether), bisphenol A epoxy di (meth)acrylate (a compound produced by reacting (meth)acrylic acid with both epoxy groups of bisphenol A diglycidyl ether), bisphenol A epoxy half (meth)acrylate (a compound produced by reacting (meth)acrylic acid or a derivative thereof with one epoxy group of bisphenol A diglycidyl ether), bisphenol F epoxy di(meth)acrylate, bisphenol F epoxy half (meth)acrylate, bisphenol S epoxy di(meth)acrylate, and bisphenol S epoxy half(meth)acrylate; compounds having an oxetanyl group and a (meth)acryloyl group in one molecule, such as 3-oxetanyl methyl (meth)acrylate, 3-methyl-3-oxetanyl methyl (meth)acrylate, 3-ethyl-3-oxetanyl methyl (meth)acrylate, 3-butyl-3-oxetanyl methyl (meth)acrylate, and 3-hexyl-3-oxetanyl methyl (meth)acrylate; and compounds having a vinyl ether group and a (meth)acryloyl group in one molecule, such as 2-vinyloxy ethyl (meth)acrylate, 3-vinyloxy propyl (meth)acrylate, 1-methyl-2-vinyloxy ethyl (meth)acrylate, 2-vinyloxy propyl (meth)acrylate, 4-vinyloxy butyl (meth)acrylate, 1-methyl-3-vinyloxy propyl (meth)acrylate, 1-vinyloxy methylpropyl (meth)acrylate, 2-methyl-3-vinyloxy propyl (meth)acrylate, 1,1-dimethyl-2-vinyloxy ethyl (meth)acrylate, 3-vinyloxy butyl (meth)acrylate, 1-methyl-2-vinyloxy propyl (meth)acrylate, 2-vinyloxy butyl (meth)acrylate, 4-vinyloxy cyclohexyl (meth)acrylate, 6-vinyloxy hexyl (meth)acrylate, 4-vinyloxy methyl cyclohexyl methyl (meth)acrylate, 3-vinyloxy methyl cyclohexyl methyl (meth)acrylate, 2-vinyloxy cyclohexyl methyl (meth)acrylate, p-vinyloxy methylphenyl methyl (meth)acrylate, m-vinyloxymethylphenylmethyl (meth)acrylate, o-vinyloxymethylphenylmethyl (meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy) propyl (meth)acrylate, 2-(vinyloxyisopropoxy)isopropyl (meth)acrylate, 2-(vinyloxyethoxyethoxy ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate.

From a point of view of flex resistance and surface hardness of the hardcoat-less film, the active energy ray-curable compound is preferably a compound having an epoxy group and/or a hydroxy group as a cationically polymerizable functional group and a (meth)acryloyl group as an active energy ray polymerizable functional group in one molecule, and specifically, preferable examples thereof include 3,4-epoxycyclohexylmethyl (meth)acrylate, glycidyl (meth)acrylate, tripropylene glycol diglycidyl ether half (meth)acrylate, bisphenol A epoxy half (meth)acrylate, bisphenol F epoxy half (meth)acrylate, and bisphenol S epoxy half (meth)acrylate.

The active energy ray-curable compound can be produced by a known method, and, for example, is produced by a method in which some of cationically polymerizable functional groups in a compound including two or more cationically polymerizable functional groups (e.g., epoxy groups or hydroxy groups) in one molecule are allowed to react with a carboxylic acid including an active energy ray polymerizable functional group (e.g., acrylic acid, methacrylic acid, etc.) or a derivative thereof. As the active energy ray-curable compound, there can also be used, for example, commercially available products such as “Light Ester G”, “Epoxy Ester 200PA”, “Epoxy Ester 200PA-E5” (product names, these are available from Kyoeisha Chemical Co., Ltd.), and “NK OLIGO EA1010N” (product name, available from SHIN-NAKAMURA CHEMICAL Co., Ltd).

The content proportion of the active energy ray-curable compound in the curable composition is not particularly limited, but is preferably from 0.1 to 5 mass %, more preferably from 0.3 to 4 mass %, and still more preferably from 0.6 to 3 mass % per the total amount (100 mass %) of the curable compound. When the content proportion is within the range set forth above, the dispersibility of the radical-curable polyorganosiloxane tends to be further improved.

The content of the active energy ray-curable compound is not particularly limited, but is preferably from 0.01 to 5 parts by mass, more preferably from 0.05 to 4 parts by mass, and still more preferably from 0.1 to 3 parts by mass per 100 parts by mass of the cationically polymerizable silsesquioxane. When the content is within the range set forth above, the dispersibility of the radical-curable polyorganosiloxane tends to be further improved.

The curable compound preferably contains an aliphatic compound having a cationically polymerizable functional group (cationically curable aliphatic compound). In this case, flexibleness can be imparted to the hardcoat-less film, and flexibility and flex resistance can be further enhanced. Note that the cationically curable aliphatic compound is a compound that does not correspond to either the cationically polymerizable silsesquioxane or the active energy ray-curable compound.

Examples of the cationically polymerizable functional group included in the cationically curable aliphatic compound include those exemplified and described as the cationically polymerizable functional group included in the cationically polymerizable silsesquioxane, and among them, an epoxy group is preferable, and a glycidyl group is more preferable from a point of view of reactivity.

The number of cationically polymerizable functional groups included in one molecule of the cationically curable aliphatic compound is preferably 2 or more, more preferably from 2 to 5, still more preferably from 2 to 3, and particularly preferably 2.

The functional group equivalent of the cationically polymerizable functional group in the cationically curable aliphatic compound is not particularly limited, but is preferably from 50 to 500, more preferably from 80 to 480, and still more preferably from 120 to 450. When the functional group equivalent is 50 or more, the hardcoat-less film is more excellent in flex resistance. When the functional group equivalent is 500 or less, the surface hardness of the hardcoat-less film is further enhanced. Note that the functional group equivalent can be calculated by the following equation.

[Functional group equivalent of cationically polymerizable functional group]=[Molecular weight of the cationically curable aliphatic compound]/[Number of cationically polymerizable functional groups included in the cationically curable aliphatic compound]

The “aliphatic compound” in the cationically curable aliphatic compound is an aliphatic compound having no cyclic structure other than the cationically polymerizable functional group. Examples of the cationically curable aliphatic compound include: glycidyl ethers of dihydric or higher polyhydric alcohols having no cyclic structure; and glycidyl esters of dicarboxylic or higher polycarboxylic acids [e.g., adipic acid, sebacic acid, maleic acid, itaconic acid, etc.]. Examples of the dihydric or higher polyhydric alcohols having no cyclic structure include dihydric alcohols such as ethylene glycol, 1,2-propanediol, 1,3-propanediol, 1,4-butanediol, neopentyl glycol, 1,6-hexanediol, diethylene glycol, triethylene glycol, tetraethylene glycol, dipropylene glycol, polyethylene glycol, and polypropylene glycol; and trihydric or higher polyhydric alcohols such as glycerin, diglycerin, erythritol, trimethylolethane, trimethylolpropane, pentaerythritol, dipentaerythritol, and sorbitol.

Note that the dihydric or higher polyhydric alcohol may be polyether polyol, polyester polyol, polycarbonate polyol, polyolefin polyol, or the like.

The cationically curable aliphatic compound is preferably a compound having two cationically polymerizable functional groups at both terminals of the aliphatic compound, and specifically, a compound represented by Formula (A) below is preferable.

E¹—O—M—O—E² (A)

In Formula (A) above, M represents a linear or branched alkylene group having from 2 to 10 carbons. Examples of the linear or branched alkylene group having from 2 to 10 carbons include linear or branched alkylene groups having from 2 to 10 carbons, such as an ethylene group, a propylene group, a trimethylene group, a tetramethylene group, a pentamethylene group, a hexamethylene group, and a decamethylene group. Among them, M is preferably a linear or branched alkylene group having from 3 to 8 carbons, more preferably a linear alkylene group having from 5 to 7 carbons, and still more preferably a linear alkylene group having 6 carbons (hexamethylene group) from a point of view of improving the surface hardness, bendability, and flex resistance of the hardcoat-less film and a point of view of making the antifouling performance less likely to deteriorate.

In Formula (A) above, E¹ and E² are the same as or different from each other and each represent a cationically polymerizable functional group, and each are preferably a group represented by Formula (E) below from a point of view of improving reactivity, surface hardness of the hardcoat-less film, bendability, and flex resistance, and a point of view of making the antifouling performance less likely to deteriorate.

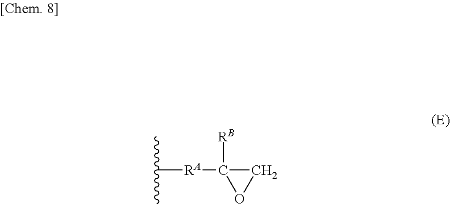

In Formula (E), R^{A} represents a linear or branched alkylene group having from 1 to 6 carbons. Examples of the linear or branched alkylene group having from 1 to 6 carbons include a methylene group, a methylmethylene group, a dimethylmethylene group, an ethylene group, a propylene group, a trimethylene group, a tetramethylene group, a pentamethylene group, a hexamethylene group, and a decamethylene group. Among them, R^{A} is preferably a linear alkylene group having from 1 to 4 carbons, more preferably a methylene group or an ethylene group, and still more preferably a methylene group from a point of view of improving the reactivity, the surface hardness, bendability, and flex resistance of the hardcoat-less film, and a point of view of making the antifouling performance less likely to deteriorate. R^{B} is a hydrogen atom or a linear or branched alkyl group having from 1 to 6 carbons, preferably a hydrogen atom or a methyl group, and more preferably a hydrogen atom.

Specific examples of the cationically curable aliphatic compound include: alkylene glycol diglycidyl ethers (alkanediol diglycidyl ethers) such as ethylene glycol diglycidyl ether, 1,3-propanediol diglycidyl ether, 2-methyl-1,3-propanediol diglycidyl ether, 2-butyl-2-ethyl-1,3-propanediol diglycidyl ether, 1,4-butanediol diglycidyl ether (tetramethylene glycol diglycidyl ether), neopentyl glycol diglycidyl ether, 3-methyl-2,4-pentanediol diglycidyl ether, 2,4-pentanediol diglycidyl ether, 1,5-pentanediol diglycidyl ether (pentamethylene glycol diglycidyl ether), 3-methyl-1,5-pentanediol diglycidyl ether, 2-methyl-2,4-pentanediol diglycidyl ether, 2,4-diethyl -1,5-pentanediol diglycidyl ether, 1,6-hexanediol diglycidyl ether (hexamethylene glycol diglycidyl ether), 1,7-heptanediol diglycidyl ether, 3,5-heptanediol diglycidyl ether, 1,8-octanediol diglycidyl ether, 2-methyl-1,8-octanediol diglycidyl ether, and 1,9-nonanediol diglycidyl ether; and (poly) alkylene glycol diglycidyl ethers such as diethylene glycol diglycidyl ether, propylene glycol diglycidyl ether, and triethylene glycol diglycidyl ether. Among them, 1,6-hexanediol diglycidyl ether is preferable from a point of view of improving the reactivity, the surface hardness, the bendability, and the flex resistance of the hardcoat-less film, and a point of view of making the antifouling performance less likely to deteriorate.

Examples of commercially available products of the cationically curable aliphatic compound include “Epolite 40E”, “Epolite 100E”, “Epolite 200E”, “Epolite 400E”, “Epolite 1600”, and “Epolite 1600N” (product names, these are available from Kyoeisha Chemical Co., Ltd.), and “YH-300” (product name, available from NIPPON STEEL Chemical & Material Co., Ltd.).

The content proportion of the cationically curable aliphatic compound in the curable composition is not particularly limited, but is preferably from 1 to 20 mass %, more preferably from 2 to 15 mass %, and still more preferably from 3 to 12 mass % per the total amount (100 mass %) of the curable compound. When the content proportion is within the range set forth above, the hardcoat-less film has more moderate flexibility and flex resistance.

The content of the cationically curable aliphatic compound is not particularly limited, but is preferably from 1 to 30 parts by mass, more preferably from 3 to 20 parts by mass, still more preferably from 5 to 15 parts by mass, and particularly preferably from 6 to 13 parts by mass, per 100 parts by mass of the cationically polymerizable silsesquioxane. When the content is within the range set forth above, the hardcoat-less film has more moderate flexibility and flex resistance.

The curable composition preferably contains a radical-curable polyorganosiloxane. By using the radical-curable polyorganosiloxane, the hardcoat-less film has an improved surface smoothness, and is excellent in sebum adhesion resistance, and fingerprints are less likely to get on the surface of the hardcoat-less film. Moreover, it is preferable that the active energy ray-curable polyorganosiloxane not correspond to the regulated PFAS substance, and in this case, the active energy ray-curable polyorganosiloxane exhibits the above-described effects while not corresponding to the regulated PFAS substance. The radical-curable polyorganosiloxane has radical curability, and thus corresponds to the curable compounds. A single type of the radical-curable polyorganosiloxane may be used alone, or two or more types thereof may be used.

The radical-curable polyorganosiloxane has a radically polymerizable functional group in the molecule. Examples of the radical-curable functional group include a photoradical polymerizable functional group.

Examples of the photoradical polymerizable functional group include a (meth)acryloyl group, a (meth)acrylamide group, a vinyl group, and a vinylthio group. Among them, a (meth)acryloyl group is preferable.

The polyorganosiloxane in the radical-curable polyorganosiloxane is preferably a linear polyorganosiloxane from a point of view of effectivity as a leveling agent.

The content proportion of the radical-curable polyorganosiloxane in the curable composition is not particularly limited, but is preferably from 0.01 to 5 mass %, more preferably from 0.03 to 3 mass %, and still more preferably from 0.04 to 1 mass % per the total amount (100 mass %) of the curable compound. When the content proportion is within the range set forth above, the surface of the hardcoat-less film is more excellent in the sebum adhesion resistance.

The content of the radical-curable polyorganosiloxane is not particularly limited, but is preferably from 0.01 to 5 parts by mass, more preferably from 0.03 to 3 parts by mass, and still more preferably from 0.04 to 1 parts by mass per 100 parts by mass of the cationically polymerizable silsesquioxane. When the content is within the range set forth above, the surface of the hardcoat-less film is more excellent in the sebum adhesion resistance.

The content proportion of the curable compound in the curable composition is preferably 90 mass % or more, more preferably 95 mass % or more, and still more preferably 97 mass % or more, per 100 mass % of the total amount of the nonvolatile components (the total amount excluding the solvents) in the curable composition.

When the content proportion is 90 mass % or more, the hardcoat-less film is more excellent in mechanical strength. Note that, in the present specification, the proportion of each of the components to the total amount of the nonvolatile components in the curable composition is equivalent to the proportion of components derived from each of said components in the hardcoat-less film.

The curable composition preferably contains a curing catalyst. The curing catalyst is a compound capable of initiating or accelerating a polymerization reaction of a curable compound, such as the cationically polymerizable silsesquioxane, the active energy ray-curable compound, or the cationically polymerizable aliphatic compound. A single type of the curing catalyst may be used alone, or two or more types thereof may be used.

The curing catalyst is selected depending on the type of the curable functional group included in the curable compound, and among them, a cationic polymerization initiator and/or a radical polymerization initiator are preferable. The cationic polymerization initiator is a compound that generates cationic species upon heating or irradiation with active energy rays and thereby initiating a curing reaction of the curable compound.

Examples of the cationic polymerization initiator include a photocationic polymerization initiator (photoacid generator) and a thermal cationic polymerization initiator (thermal acid generator).

As the photocationic polymerization initiator, a known or commonly used photocationic polymerization initiator can be used, and examples thereof include a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion.

Examples of the sulfonium salt include triarylsulfonium salts, such as a triphenylsulfonium salt, a tri-p-tolylsulfonium salt, a tri-o-tolylsulfonium salt, a tris(4-methoxyphenyl) sulfonium salt, a 1-naphthyldiphenylsulfonium salt, a 2-naphthyldiphenylsulfonium salt, a tris (4-fluorophenyl)sulfonium salt, a tri-1-naphthylsulfonium salt, a tri-2-naphthylsulfonium salt, a tris(4-hydroxyphenyl) sulfonium salt, a diphenyl [4-(phenylthio)phenyl] sulfonium salt, and a 4-(p-tolylthio)phenyldi-(p-phenyl) sulfonium salt; diarylsulfonium salts, such as a diphenylphenacylsulfonium salt, a diphenyl 4-nitrophenacylsulfonium salt, a diphenylbenzylsulfonium salt, and a diphenylmethylsulfonium salt; monoarylsulfonium salts, such as a phenylmethylbenzylsulfonium salt, a 4-hydroxyphenylmethylbenzylsulfonium salt, and a 4-methoxyphenylmethylbenzyl sulfonium salt; and trialkyl sulfonium salts, such as a dimethylphenacyl sulfonium salt, a phenacyl tetrahydrothiophenium salt, and a dimethyl benzylsulfonium salt.

Examples of the diphenyl [4-(phenylthio)phenyl] sulfonium salt include diphenyl [4-(phenylthio)phenyl] sulfonium tetrakis(pentafluorophenyl)borate and diphenyl [4-(phenylthio)phenyl] sulfonium hexafluorophosphate. In addition, a commercially available product such as “CPI-100P” (product name, Diphenyl [4-(phenylthio) phenyl] sulfonium hexafluorophosphate, 50% propylene carbonate solution product, available from San-Apro Ltd.) can also be used.

Examples of the iodonium salt include “RHODORSIL PHOTOINITIATOR 2074” (product name, [(1-methylethyl) phenyl](methylphenyl)iodonium tetrakis(pentafluorophenyl)borate, available from Rhodia Japan Ltd.), “WPI-124” (product name, available from Wako Pure Chemical Industries, Ltd.), diphenyliodonium salt, di-p-tolyliodonium salt, bis(4-dodecylphenyl)iodonium salt, and bis(4-methoxyphenyl)iodonium salt.

Examples of the selenium salt include triarylselenium salts, such as a triphenylselenium salt, a tri-p-tolylselenium salt, a tri-o-tolylselenium salt, a tris(4-methoxyphenyl) selenium salt, and a 1-naphthyldiphenylselenium salt; diarylselenium salts, such as a diphenylphenacylselenium salt, a diphenylbenzylselenium salt, and a diphenylmethylselenium salt; monoarylselenium salts, such as a phenylmethylbenzylselenium salt; and trialkylselenium salts, such as a dimethylphenacylselenium salt.

Examples of the ammonium salt include tetraalkyl ammonium salts, such as a tetramethyl ammonium salt, an ethyltrimethyl ammonium salt, a diethyldimethyl ammonium salt, a triethylmethyl ammonium salt, a tetraethyl ammonium salt, a trimethyl-n-propyl ammonium salt, and a trimethyl-n-butyl ammonium salt; pyrrolidium salts, such as an N,N-dimethylpyrrolidium salt and an N-ethyl-N-methylpyrrolidium salt; imidazolinium salts, such as an N,N′-dimethylimidazolinium salt and an N,N′-diethylimidazolinium salt; tetrahydropyrimidium salts, such as an N,N′-dimethyltetrahydropyrimidium salt and an N,N′-diethyltetrahydropyrimidium salt; morpholinium salts, such as an N,N-dimethylmorpholinium salt and an N,N-diethylmorpholinium salt; piperidinium salts, such as an N,N-dimethylpiperidinium salt and an N,N-diethylpiperidinium salt; pyridinium salts, such as an N-methylpyridinium salt and an N-ethylpyridinium salt; imidazolium salts, such as an N,N′-dimethylimidazolium salt; quinolium salts, such as an N-methylquinolium salt; isoquinolium salts, such as an N-methylisoquinolium salt; thiazonium salts, such as a benzylbenzothiazonium salt; and acrydium salts, such as a benzylacrydium salt.

Examples of the phosphonium salt include tetra-arylphosphonium salts, such as a tetra-phenylphosphonium salt, a tetra-p-tolylphosphonium salt, and a tetrakis(2-methoxyphenyl)phosphonium salt; triarylphosphonium salts, such as a triphenylbenzylphosphonium salt; and tetra-alkylphosphonium salts, such as a triethylbenzylphosphonium salt, a tributylbenzylphosphonium salt, a tetra-ethylphosphonium salt, a tetra-butylphosphonium salt, and a triethylphenacylphosphonium salt.

Examples of the salt of the transition metal complex ion include salts of chromium complex cations, such as (η⁵-cyclopentadienyl)(η⁶-toluene) Cr⁺ and (η⁵-cyclopentadienyl)(η⁶-xylene)Cr⁺; and salts of iron complex cations, such as (n5-cyclopentadienyl)(η⁶-toluene)Fe⁺ and (η⁵-cyclopentadienyl) (η⁶-xylene) Fe⁺.

Examples of the anion as a constituent in the above-described salt include PF₆⁻, BF₄⁻, (C₆F₅)₄B⁻, (C₆F₅)₄Ga⁻, sulfonate anions (trifluoromethanesulfonate anion, pentafluoroethanesulfonate anion, methanesulfonate anion, benzenesulfonate anion, p-toluenesulfonate anion, etc.), perhalide ions, halogenated sulfonate ions, sulfate ion, carbonate ion, aluminate ion, carboxylate ion, arylborate ion, thiocyanate ion, and nitrate ion.

Examples of the thermal cationic polymerization initiator include aryl sulfonium salts, aryl iodonium salts, allene-ion complexes, quaternary ammonium salts, aluminum chelates, and boron trifluoride amine complexes. Examples of the anion as a constituent in the above-mentioned salt include those similar to anions in the photocationic polymerization initiator.

Examples of the aryl sulfonium salt include a pentafluorophenyl borate salt and a hexafluorophosphate salt. Commercially available products can be used in the curable composition according to an embodiment of the present invention, and examples thereof include “SP-66” and “SP-77” (product names, these are available from ADEKA CORPORATION); “SAN-AID SI-150L”, “SAN-AID SI-110”, “SAN-AID SI-360”, “SAN-AID SI-300”, “SAN-AID SI-B4”, “SAN-AID SI-B5”, “SAN-AID SI-B3”, “SAN-AID SI-B3A”, “SAN-AID SI-B7”, and “SAN-AID SI-B2A” (productnames, these are available from SANSHIN CHEMICAL INDUSTRY CO., LTD.). Examples of the aluminum chelates include ethyl acetoacetate aluminum diisopropylate and aluminum tris (ethyl acetoacetate). Examples of the boron trifluoride amine complex include boron trifluoride monoethylamine complex, boron trifluoride imidazole complex, and boron trifluoride piperidine complex.

The radical polymerization initiator is a compound that generates a radical upon heating or irradiation with active energy rays and thereby initiating a curing reaction of the curable compound.

Examples of the radical polymerization initiator include a photoradical polymerization initiator and a thermal radical polymerization initiator. Examples of the photoradical polymerization initiator include alkylphenone-based photoradical polymerization initiators, acylphosphine oxide-based photoradical polymerization initiators, oxime ester-based photoradical polymerization initiators, and a-hydroxyketone-based photoradical polymerization initiators.

Examples of the alkylphenone-based photoradical polymerization initiator include oligomers of 2-hydroxy-2-methyl-1-phenylpropane-1-one, 2-benzyl-2-dimethylamino-1-(4-morpholinophenyl)-1-butanone, 2-(dimethylamino)-2- [(4-methylphenyl)methyl]-[4-(4-morpholinyl)phenyl]-1-butanone, 2-methyl-1-[4-(methylthio)phenyl]-2-morpholinopropane-1-one, benzophenone, methylbenzophenone, o-benzoylbenzoic acid, benzoylethyl ether, 2,2-diethoxyacetophenone, 2,4-diethylthioxanthone, diphenyl-(2,4,6-trimethylbenzoyl) phosphine oxide, ethyl-(2,4,6-trimethylbenzoyl)phenylphosphinate, 4,4′-bis(diethylamino)benzophenone, 1-hydroxycyclohexyl phenyl ketone, 2,2-dimethoxy-1,2-diphenylethane-1-one, 1-[4-(2-hydroxyethoxy)phenyl]-2-hydroxy-2-methyl-1-propane-1-one, and 2-hydroxy-1-(4-isopropenylphenyl)-2-methylpropane-1-one.

Examples of the acylphosphine oxide-based photoradical polymerization initiator include 2,4,6-trimethylbenzoyldiphenylphosphine oxide and bis(2,4,6-trimethylbenzoyl)phenylphosphine oxide.

Examples of the oxime ester-based photoradical polymerization initiator include 1-[4-(phenylthio)phenyl]-1,2-octanedione 2-(O-benzoyloxime) and 1-[6-(2-methylbenzoyl)-9-ethyl-9H-carbazol-3-yl]ethanone O-acetyloxime.

Examples of the α-hydroxyketone-based photoradical polymerization initiator include benzoin, benzoin methyl ether, benzoin butyl ether, 1-hydroxycyclohexyl phenyl ketone, 1-phenyl-2-hydroxy-2-methylpropane-1-one, 1-(4-i-propylphenyl)-2-hydroxy-2-methylpropane-1-one, 4-(2-hydroxyethoxy) phenyl-(2-hydroxy-2-propyl) ketone, and 1-hydroxycyclohexyl phenyl ketone.

The content (blending amount) of the curing catalyst in the curable composition is not particularly limited, but is preferably from 0.01 to 10 parts by mass, more preferably from 0.05 to 5 parts by mass, still more preferably from 0.1 to 3 parts by mass, still more preferably from 0.3 to 2.7 parts by mass, and particularly preferably from 0.5 to 2.5 parts by mass, per 100 parts by mass of the total amount of the curable compound. When the content of the curing catalyst is 0.01 parts by mass or more, the curing reaction can be allowed to efficiently and adequately proceed, and the surface hardness of the cured product tends to be further improved. On the other hand, when the content of the curing catalyst is 10 parts by mass or less, the shelf life of the curable composition tends to be improved or the coloring of the cured product tends to be suppressed.

The content (blending amount) of the cationic polymerization initiator in the curable composition is not particularly limited, but is preferably from 0.01 to 10 parts by mass, more preferably from 0.05 to 5 parts by mass, still more preferably from 0.1 to 3 parts by mass, and particularly preferably from 0.3 to 2 parts by mass, per 100 parts by mass of the total amount of the curable compound. When the content is 0.01 parts by mass or more, the curing reaction can be allowed to efficiently and adequately proceed, and the surface hardness of the cured product tends to be further improved. When the content is 10 parts by mass or less, the shelf life of the curable composition tends to be improved or the coloring of the cured product tends to be suppressed.

The content (blending amount) of the radical polymerization initiator in the curable composition is not particularly limited, but is preferably from 0.005 to 5 parts by mass, more preferably from 0.01 to 3 parts by mass, still more preferably from 0.05 to 2 parts by mass, and particularly preferably from 0.1 to 1 parts by mass, per 100 parts by mass of the total amount of the curable compound. When the content is 0.005 parts by mass or more, the curing reaction can be allowed to efficiently and adequately proceed, and the surface hardness of the cured product tends to be further improved. When the content is 5 parts by mass or less, the shelf life of the curable composition tends to be improved or the coloring of the cured product tends to be suppressed.

The curable composition may further contain another component besides the components described above. Examples of the other component that can be included in the curable composition include commonly used additives including inorganic fillers, such as precipitated silica, wet silica, fumed silica, calcined silica, titanium dioxide, alumina, glass, quartz, aluminosilicate, iron oxide, zinc oxide, calcium carbonate, carbon black, silicon carbide, silicon nitride, and boron nitride, and inorganic fillers which are the abovementioned fillers treated with an organosilicon compound such as organohalosilane, organoalkoxysilane, or organosilazane; organic resin fine powders, such as silicone resin, epoxy resin, or fluororesin fine powders; fillers such as powders of conductive metal such as silver, copper etc., curing agents (amine-based curing agents, polyaminoamide-based curing agents, acid anhydride-based curing agents, phenol-based curing agents, etc.), curing auxiliaries, curing accelerators (imidazoles, alkali metal or alkaline earth metal alkoxides, phosphines, amide compounds, Lewis acid complex compounds, sulfur compounds, boron compounds, condensable organometallic compounds, etc.), solvents (water, organic solvents, etc.), stabilizers (antioxidants, ultraviolet absorbers, light stabilizers, heat stabilizers, heavy metal deactivators, etc.), flame retardants (phosphorus-based flame retardants, halogen-based flame retardants, inorganic flame retardants, etc.), flame retardant promoters, reinforcing materials (other fillers, etc.), nucleating agents, coupling agents (silane coupling agents, etc.), lubricants, waxes, plasticizers, release agents, impact modifiers, hue improvers, clarifying agents, rheology modifiers (fluidity improvers, etc.), processability improvers, colorants (dyes, pigments, etc.), antistatic agents, dispersants, surface conditioners (anti-popping agents, etc.), surface modifiers (slip agents, etc.), matting agents, antifoaming agents, foam suppressors, deforming agents, antibacterial agents, antiseptics, viscosity modifiers, thickeners, photosensitizers, foaming agents, and surfactants. A single type of the other component may be used alone, or two or more types thereof may be used. The content (blending amount) of the other component is not particularly limited, but is preferably 100 parts by mass or less, more preferably 30 parts by mass or less (e.g., from 0.01 to 30 parts by mass), and still more preferably 10 parts by mass or less (e.g., from 0.1 to 10 parts by mass), per 100 parts by mass of the total amount of the curable compound.

As the above-described solvent, examples that may be mentioned include known and commonly used organic solvents, and examples thereof include ketones (acetone, methyl ethyl ketone, methyl isobutyl ketone, cyclohexanone, etc.), ethers (dioxane, tetrahydrofuran, etc.), aliphatic hydrocarbons (hexane, etc.), alicyclic hydrocarbons (cyclohexane, etc.), aromatic hydrocarbons (benzene, etc.), halogenated hydrocarbons (dichloromethane, dichloroethane, etc.), esters, alcohols (ethanol, cyclohexanol, etc.), cellosolves (methyl cellosolve, ethyl cellosolve, etc.), cellosolve acetates, and amides (dimethylformamide, dimethylacetamide, etc.).

The curable composition can be prepared by, but not particularly limited to, stirring and mixing the various components described above at room temperature or under heating as necessary.

### Cured Product, Hardcoat-Less Film

The curable composition can be cured to afford the cured product (hardcoat-less film). The pencil hardness of the surface of the hardcoat-less film is not particularly limited, but is preferably H or higher (e.g., from H to 9H), more preferably 2H or higher, still more preferably 3H or higher, still more preferably 4H or higher, still more preferably 5H or higher, still more preferably 6H or higher, still more preferably 7H or higher, still more preferably 8H or higher, and particularly preferably 9H. Here, the pencil hardness can be evaluated according to the method described in JIS K5600-5-4.

A part or the whole of the surface of the hardcoat-less film may be subjected to a known or commonly used surface treatment such as a roughening treatment, an easy adhesion treatment, an antistatic treatment, a sandblasting treatment (sand matting treatment), an electrical discharge treatment (e.g., corona discharge treatment, glow discharge treatment, etc.), a plasma treatment, a chemical etching treatment, a water matting, a flame treatment, an acid treatment, an alkali treatment, an oxidation treatment, an irradiation treatment with ultraviolet rays or a treatment with a silane coupling agent, for the purpose such as an improvement of adhesion to another layer.

The hardcoat-less film is produced in a manner in which the curable composition is applied onto a release-treated surface of a temporary base material such as a separator, a solvent is removed by drying as necessary, then a polymerization reaction of a curable compound in the curable composition is allowed to proceed, thereby the curable composition is cured to give a cured product, and then the cured product is removed from the temporary base material.

As a method for applying the curable composition, a known or commonly used application method can be used. Examples of the coating applicators include a roll coater, an air knife coater, a blade coater, a rod coater, a reverse coater, a bar coater, a comma coater, a dip squeeze coater, a die coater, a gravure coater, a micro gravure coater, a silk screen coater, and a spray coater. Besides a method using a coating apparatus, examples of the application method also include a dip method (dip coating) and a spinner method. Among them, application with a spray coater (spray coating) is suitable.

The curing method can be appropriately selected from known methods, and is not particularly limited, but is appropriately selected according to the type of a curable functional group included in the curable compound, and examples thereof include a method of irradiation with active energy rays and a method of heating. As the active energy rays, for example, any of infrared rays, visible rays, ultraviolet rays, X-rays, an electron beam, an a-ray, a B-ray, and a y-ray can be used. Among them, ultraviolet rays are preferable in terms of easy handling. The irradiation with the active energy rays (especially, electron beams) is preferably performed in an inert gas atmosphere such as a nitrogen atmosphere, an argon atmosphere, or a helium atmosphere.

Heating may be performed at the time when the solvent is removed after application of the curable composition. The temperature at the time when the solvent is removed is not particularly limited, but is preferably from 40 to 200° C., more preferably from 50 to 170° C., still more preferably from 60 to 150° C., and particularly preferably from 80 to 140° C. The period of time for which the temperature should be maintained within the range set forth above is not particularly limited, but is preferably for a period of time ranging from about 30 seconds to 5 hours.

The conditions at the time when the curable composition is cured by irradiation with the active energy rays (conditions of irradiation with the active energy rays, etc.) can be appropriately adjusted depending on the type and the energy of the active energy rays to apply, the shape and the size of the hardcoat-less film, and the like, and are not particularly limited, but when applying ultraviolet rays, they are preferably adjusted in a range from about 1 to 10000 mJ/cm² (preferably from 50 to 5000 mJ/cm^{2,} more preferably from 70 to 3000 mJ/cm^{2,} further preferably from 100 to 1000 mJ/cm²). Note that, examples that can be used to apply active energy rays include: a Deep UV lamp, a high-pressure mercury lamp, an ultra-high-pressure mercury lamp, a low-pressure mercury lamp, a xenon lamp, a carbon arc, a metal halide lamp, sunlight, an LED lamp, a halogen lamp, and a laser (e.g., a helium-cadmium laser, an excimer laser, etc.). After the irradiation with active energy rays, a heat treatment (annealing, aging) can be additionally performed thereby allowing the curing reaction to further proceed.

The illumination dose when the curable composition is cured by irradiating with electron beams is not particularly limited, but is preferably from 1 to 200 kGy, more preferably from 5 to 150 kGy, still more preferably from 10 to 100 kGy, and particularly preferably from 20 to 80 kGy. The accelerating voltage is not particularly limited, but is preferably from 10 to 1000 kV, more preferably from 50 to 500 kV, and still more preferably from 100 to 300 kV.

In the aging, the heating temperature is not particularly limited, but is preferably from 30 to 200° C., more preferably from 50 to 190° C., and still more preferably from 60 to 180° C. The heating time is not particularly limited, but is preferably from 10 minutes to 10 hours, more preferably from 30 minutes to 5 hours, and still more preferably from 45 minutes to 3 hours.

### Laminate

A laminate can be produced by layering another layer on the hardcoat-less film. Examples of the other layer include functional layers capable of imparting various functions. The laminate includes the hardcoat-less film and a functional layer that is layered on the hardcoat-less film. The other layer may consist of a single layer only, or may include two or more layers.

Examples of the functional layer include a surface protection film for protecting the surface of the hardcoat-less film, a hardcoat layer, an antireflection layer, an anti-glare layer, an anti-fingerprint layer, an antifouling layer, an abrasion resistance layer, a scratch-resistant fingerprint-resistant layer, an antibacterial layer, a bonding layer, a polarizing layer, and an optical base material. The functional layer is preferably a layer formed of a thermosetting resin composition or of an active energy ray-curable resin composition, and more preferably a layer formed of an active energy ray-curable resin composition. Furthermore, it may be used by attaching it onto a base material such as glass.

When the surface protection film is provided, punching processability and ease of handling of the hardcoat-less film tend to be improved. When the surface protection film is provided as described above, for example, even if the hardcoat-less film has a very high hardness and is easily peeled off from the support or cracks are prone to occur during punching, punching using the Thomson blade can be performed without causing such problems.

The surface protection film is not particularly limited, and a well-known or commonly used surface protection film can be used. For example, a film having a tacky adhesive agent layer on the surface of the plastic film can be used. Examples of the plastic film include plastic films formed from plastic materials such as polyesters (e.g., polyethylene terephthalate, polyethylene naphthalate), polyolefins (e.g., polyethylene, polypropylene, cyclic polyolefins), polystyrenes, acrylic resins, polycarbonates, epoxy resins, fluororesins, silicone resins, diacetate resins, triacetate resins, polyarylates, polyvinyl chlorides, polysulfones, polyethersulfones, polyether ether imides, polyimides, and polyamides. Examples of the tacky adhesive agent layer include a tacky adhesive agent layer formed from one or more types of known or commonly used tacky adhesive agents such as acrylic tacky adhesive agents, natural rubber-based tacky adhesive agents, synthetic rubber-based tacky adhesive agents, ethylene-vinyl acetate copolymer-based tacky adhesive agents, ethylene-(meth)acrylate copolymer-based tacky adhesive agents, styrene-isoprene block copolymer-based tacky adhesive agents, and styrene-butadiene block copolymer-based tacky adhesive agents. Various additives (for example, antistatic agents, and slip agents) may be included in the tacky adhesive agent layer. Note that the plastic film and the tacky adhesive agent layer may each have a single layer configuration or may have a multilayer (multiple layer) configuration. The thickness of the surface protection film is not particularly limited, and can be appropriately selected.

Examples of the surface protection film that are available on the market include commercially available products such as “SUNYTECT” series (product name, available from Sun A. Kaken Co., Ltd.), “E-MASK” series (product name, available from Nitto Denko Corporation), “MASTACK” series (product name, available from FUJIMORI KOGYO CO., LTD.), “Hitarex” series (product name, available from Hitachi Chemical Company, Ltd.), and “ALPHAN” series (product name, available from Oji F-Tex Co., Ltd.).

Specific examples of the laminate include those having a layer configuration such as [hardcoat-less film/bonding layer/surface protection film], [hardcoat-less film/bonding layer/antireflection layer], [hardcoat-less film/anti-glare layer/surface protection film], [hardcoat-less film/base material/bonding layer], [glass/hardcoat-less film/surface protection film], [glass/hardcoat-less film/bonding layer], [hardcoat-less film/anti-fingerprint layer/scratch-resistant fingerprint-resistant layer], [hardcoat-less film/antifouling layer/surface protection film], [hardcoat-less film/anti-glare layer/antireflection layer], [hardcoat-less film/antireflection layer/anti-fingerprint layer], [hardcoat-less film/bonding layer/glass], [hardcoat-less film/bonding layer/polarizing layer], [glass/hardcoat-less film/polarizing layer], [glass/hardcoat-less film/bonding layer/polarizing layer] or [glass/hardcoat-less film/antireflection layer]. Moreover, a multilayer laminate is produced by layering a plurality of the laminates.

The laminate such as the multilayer laminate can be used as various products, members thereof, or constituent materials of components. Examples of the products include various home electric appliances, various electric and electronic products, and various optical devices, and examples thereof include display devices such as liquid crystal displays and organic EL displays; input devices such as touch panels: solar cells; portable electronic terminals such as game consoles, personal computers, tablets, smartphones, and mobile phones; display devices such as displays in automobiles; spectacle lenses; and transparent members used outdoors or under a severe environment at high temperature, at high humidity etc., such as a headlight of an automobile, FA, and camera lenses for a monitoring camera etc. The hardcoat-less film is preferably a layer that protects the surface of the product.

Each aspect disclosed in the present specification can be combined with any other feature disclosed herein. Note that each of the configurations, combinations thereof, or the like in each of the embodiments are examples, and additions, omissions, replacements, and other changes to the configurations may be made as appropriate without departing from the spirit of the present disclosure. In addition, each aspect of the invention according to the present disclosure is not limited by the embodiments or the following examples but is limited only by the claims.

### EXAMPLES

An embodiment of the present disclosure will be described in detail below based on Examples. Note that, the molecular weight of the product was measured by using the following:
Alliance HPLC system 2695 (available from Waters),
Refractive Index Detector 2414 (available from Waters),
column: Tskgel GMHHR-M × 2 (available from Tosoh Corporation),
guard column: Tskgel guard column HHRL (available from Tosoh Corporation),
column oven: COLUMN HEATER U-620 (available from Sugai),
solvent: THF,
measurement condition: 40° C., and
molecular weight: calibrated with standard polystyrene.

The ratio of the T3 form to the T2 form [T3 form/T2 form] in the product was measured by ²⁹Si-NMR spectroscopy with JEOL ECA500 (500 MHZ). T_{d5} (5% weight loss temperature) of the product was measured by TGA (thermogravimetric analysis) under a condition of a heating rate of 5° C./min in an air atmosphere.

### Example 1

### Preparation of Epoxy Group-Containing Silsesquioxane

Into a 300 milliliter flask (reaction vessel) equipped with a thermometer, a stirrer, a reflux condenser, and a nitrogen inlet tube were put 161.5 mmol (39.79 g) of 2-(3,4-epoxycyclohexyl)ethyltrimethoxysilane, 9 mmol (1.69 g) of phenyltrimethoxysilane, and 165.9 g of acetone under a nitrogen stream, and the temperature was raised to 50° C. To the mixture thus produced, 4.70 g of 5% potassium carbonate aqueous solution (1.7 mmol as potassium carbonate) was added dropwise over 5 minutes, and then 1700 mmol (30.60 g) of water was added dropwise over 20 minutes. Note that no significant temperature increase occurred during the dropwise addition. Thereafter, the polycondensation reaction was carried out under a nitrogen stream for 4 hours while the temperature was maintained at 50° C.

After the polycondensation reaction, the product in the reaction solution was analyzed, and the number average molecular weight was found to be 1911, and the molecular weight dispersity was found to be 1.47. The ratio of the T3 form to the T2 form [T3 form/T2 form] calculated from the 29Si-NMR spectrum of the product was found to be 10.3.

Thereafter, the reaction solution was cooled and washed with water until the bottom layer liquid became neutral, the upper layer liquid was separated from the bottom layer liquid, and then the solvent was removed from the upper layer liquid by distillation under the conditions of 1 mmHg and 40° C. and thereby giving a colorless transparent liquid product (epoxy group-containing silsesquioxane, solid content: 77 mass %). The T_{d5} of the above product was found to be 370° C.

### Preparation of Curable Composition 1

As Curable compound 1, a curable composition was prepared by mixing 66.8 parts by mass of the epoxy group-containing silsesquioxane produced as described above (active ingredient: 77 mass %), 1.5 parts by mass of “Epoxy Ester 200PA-E5” (product name, a compound having acryloyl group, epoxy group, and polyglycerin skeleton, available from Kyoeisha Chemical Co., Ltd.), 6.2 parts by mass of 1,6-hexanediol diglycidyl ether (product name: “Epolite 1600”, available from Kyoeisha Chemical Co., Ltd.), and 0.2 parts by mass of a radical-curable functional group-containing polyorganosiloxane (product name: “MEGAFACE RS-57”, active ingredient: 20 mass %, not corresponding to the regulated PFAS substance, available from DIC Corporation, active ingredient: 20 mass %), with 0.5 parts by mass of a photocationic polymerization initiator (a salt of triarylsulfonium and tetrapentafluorophenylgallium) and 0.2 parts by mass of a photoradical polymerization initiator (product name: “Omnirad127”, available from IGM Resins) as curing catalysts, 0.4 parts by mass of an antioxidant (product name: “AO-20”, available from ADEKA CORPORATION), and 8.4 parts by mass of methyl isobutyl ketone (MIBK) and 15.8 parts by mass of methyl ethyl ketone (MEK) as solvents. Note that the content proportions shown in Table 1 are the blending proportions of the components, those for the silsesquioxane and RS-57 are shown as a value of the solution, and those for the other components are shown as the values of the active ingredients.

### Preparation of Hardcoat-Less Film

The release-treated surface of a separator placed on a Teflon (trade name) frame was spray-coated with Curable composition 1 above by using a hand spray gun (available from ANEST IWATA Corporation). Thereafter, drying (at 80° C. for 2 hours) and irradiation with UV (at 300 mJ/cm²) were performed, then the Teflon (trade name) frame was removed, and aging was performed at 120°° C. for 1 hour to cure the composition, resulting in the formation of a cured product (hardcoat-less film) having a thickness of about 0.150 mm.

### Example 2

### Preparation of Curable Composition 2

Curable composition 2 was prepared in the same manner as for Curable composition 1 except that the content proportions of the components were changed as shown in Table 1. “Epolite 400E” shown in Table 1 is “Epolite 400E” (product name, Polyethylene glycol #400 diglycidyl ether, available from Kyoeisha Chemical Co., Ltd.).

### Preparation of Hardcoat-Less Film

A cured product (ca. 0.150 mm in thickness) (hardcoat-less film) of Example 2 was prepared in the same manner as in Example 1 except that Curable composition 2 above was used.

### Example 3

### Preparation of Curable Composition 3

Curable composition 3 was prepared in the same manner as for Curable composition 1 except that the content proportions of the components were changed as shown in Table 1.

### Preparation of Hardcoat-Less Film

A cured product (ca. 0.150 mm in thickness) (hardcoat-less film) of Example 3 was prepared in the same manner as in Example 1 except that Curable composition 3 above was used.

The cured products (hardcoat-less films) produced in Examples 1 to 3 were evaluated as follows. The results are shown in Table 1.

### (1) Surface Hardness (Pencil Hardness)

The pencil hardness of the surface of the hardcoat-less film produced as described above was evaluated according to JIS K56006-4.

### (2) Tensile Test

The hardcoat-less film produced as described above was punched into a shape of No. 7 dumbbell (JIS K6251) and used as a test piece. A test was performed at a tensile test speed of 2 mm/min, a chuck distance of 20 mm, and a gauge length of 12 mm in accordance with JIS K7161 (1994) using a TENSILON universal material testing machine (product name “RTF-1350”, available from A&D Company, Limited).

A tensile test was performed for eight test pieces (n=8), and an average value excluding the two points at the upper and lower limits from the resulting Young's moduli was determined to be the Young's modulus for the evaluation result.

### (3) Indentation Test

For the hardcoat-less film produced as described above, ten indentations produced by a Berkovich tip with a maximum load of 500 μN were measured by using a nanoindenter (product name: “ENT-2100”, available from ELIONIX INC.) and the averaged values of the indentation hardness and Young's moduli were determined.

### (4) Glass Transition Temperature and Melting Point

A differential scanning calorimeter (product name: “DSC-6220”, available from Hitachi High-Tech Science Corporation) was used to perform DSC measurement in a temperature range from room temperature to 300°° C. for the cured product produced as described above. As a result, neither baseline shift due to glass transition temperature nor peak derived from the melting point were observed in any of Examples 1 to 3 within the range of 300° C. or lower.

TABLE 1

| | | Example 1 | Example 2 | Example 3 |
|---|---|---|---|---|
| Curable composition | | (1) | (2) | (3) |
| Curable compounds | Silsesquioxane | 66.8 | 65.6 | 65.6 |
| | 200PA-E5 | 1.5 | 1.5 | 1.5 |
| | Epolite 1600 | 6.2 | 1.5 | 1.2 |
| | Epolite 400E | — | 5.9 | 6.2 |
| | RS-57 | 0.2 | 0.2 | 0.2 |
| Curing catalysts | Salt of triarylsulfonium and | 0.5 | 0.5 | 0.5 |
| | tetrapentafluorophenylgallium | | | |
| | Omnirad 127 | 0.2 | 0.2 | 0.2 |
| Antioxidant | AO-20 | 0.4 | 0.4 | 0.4 |
| Solvents | MIBK | 8.4 | 8.4 | 8.4 |
| | MEK | 15.8 | 15.8 | 15.8 |
| Evaluation Results | Pencil hardness | 7H | 4H | 3H |
| | Young's modulus (in tensile | 1878 | 1820 | 1028 |
| | test) [MPa] | | | |
| | Indentation hardness (in | 740 | 236 | 151 |
| | indentation test) [MPa] | | | |
| | Young's modulus (in | 4572 | 3409 | 2592 |
| | indentation test) [MPa] | | | |
| | Elastic-to-plastic ratio (in | 85 | 77 | 72 |
| | indentation test) [%] | | | |

As shown in the evaluation results in Table 1, the hardcoat-less film of Example 1 was determined to have a moderate Young's modulus in the tensile test, a sufficiently high elastic-to-plastic ratio in the indentation test and a sufficiently high Young's modulus in the indentation test, and excellent mechanical strength even without using any regulated PFAS substance. Moreover, the hardcoat-less film of Example 1 is made of a resin instead of glass, and is lighter than glass. Furthermore, neither the glass transition temperature nor the melting point were confirmed at 300° C. or lower, and it was determined that the hardcoat-less film of Example 1 was excellent in heat resistance.

Hereinafter, variations of the invention according to the present disclosure will be described.
[Supplementary note 1] A hardcoat-less film that fulfills a condition that an elastic-to-plastic ratio is 70% or more in an indentation test and a glass transition temperature and a melting point each are neither lower than nor equal to 200° C., and fulfills at least one of a condition that a Young's modulus is 1000 MPa or more in an indentation test or a condition that a Young's modulus is from 1000 to 5000 MPa in a tensile test.
[Supplementary note 2] The hardcoat-less film according to Supplementary note 1, wherein the hardcoat-less film has a thickness from 1 to 1000 μm, and an indentation hardness of 100 MPa or more in an indentation test.
[Supplementary note 3] The hardcoat-less film according to Supplementary note 1 or 2, wherein the hardcoat-less film is formed of a cured product of a curable composition, and the cured product has a glass transition temperature of 300° C. or higher.
[Supplementary note 4] The hardcoat-less film according to any one of Supplementary notes 1 to 3, wherein the hardcoat-less film is formed of a cured product of a curable composition, and the cured product has a pencil hardness of 2H or higher.
[Supplementary note 5] The hardcoat-less film according to Supplementary note 3 or 4, wherein the curable composition contains a radical-curable polyorganosiloxane.
[Supplementary note 6] The hardcoat-less film according to any one of Supplementary notes 3 to 5, wherein the curable composition contains a cationically polymerizable silsesquioxane.
[Supplementary note 7] The hardcoat-less film according to any one of Supplementary notes 3 to 6, wherein the curable composition further contains a curable compound containing an active energy ray polymerizable functional group.
[Supplementary note 8] A laminate including:
   the hardcoat-less film described in any one of Supplementary notes 1 to 7; and a functional layer that is layered on the hardcoat-less film.
[Supplementary note 9] A multilayer laminate including a plurality of the laminates described in Supplementary note 8 that is layered.
[Supplementary note 10] A display device including the multilayer laminate described in Supplementary note 9.

1. A hardcoat-less film that fulfills a condition that an elastic-to-plastic ratio is 70% or more in an indentation test and a glass transition temperature and a melting point each are neither lower than nor equal to 200° C., and fulfills at least one of a condition that a Young's modulus is 1000 MPa or more in an indentation test or a condition that a Young's modulus is from 1000 to 5000 MPa in a tensile test.

2. The hardcoat-less film according to claim 1, wherein the hardcoat-less film has a thickness from 1 to 1000 μm, and an indentation hardness of 100 MPa or more in an indentation test.

3. The hardcoat-less film according to claim 1, wherein the hardcoat-less film is formed of a cured product of a curable composition, and the cured product has a glass transition temperature of 300°° C. or higher.

4. The hardcoat-less film according to claim 1, wherein the hardcoat-less film is formed of a cured product of a curable composition, and the cured product has a pencil hardness of 2H or higher.

5. The hardcoat-less film according to claim 3, wherein the curable composition comprises a radical-curable polyorganosiloxane.

6. The hardcoat-less film according to claim 3, wherein the curable composition comprises a cationically polymerizable silsesquioxane.

7. The hardcoat-less film according to claim 6, wherein the curable composition further comprises a curable compound containing an active energy ray polymerizable functional group.

8. A laminate comprising:
the hardcoat-less film described in claim 1; and
a functional layer that is layered on the hardcoat-less film.

9. A multilayer laminate comprising a plurality of the laminates described in claim 8 that is layered.

10. A display device comprising the multilayer laminate described in claim 9.
